(19) United States
(12) Patent Application Publication
(10) Pub. No.: US 2012/0321750 A1
(43) Pub. Date: Dec. 20, 2012

(54) Complex Confectionery Products

(76) Inventor: James Klene, Atlanta, GA (US)

(21) Appl. No.: 13/495,486

(22) Filed: Jun. 13, 2012

Related U.S. Application Data
(60) Provisional application No. 61/496,824, filed on Jun. 14, 2011.

(51) Int. Cl. A23G 1/54; A23G 1/32; A23P 1/10; A23G 3/42; A23G 3/50; A23G 3/54

(52) U.S. Cl. 426/93; 426/282; 426/289; 426/576; 426/250; 426/575

(57) ABSTRACT

The present invention describes novel processes for manufacturing a complex confection comprising a first confection that has an edible hollow shell and a separately-formed second confection that is also edible and rests within the first confection. Novel products and processes are described.

### CROSS-REFERENCE TO RELATED APPLICATIONS

This application claims priority under 35 U.S.C. §119(e) to and benefit of U.S. Provisional Application Ser. No. 61/496,824, filed Jun. 14, 2011, which is incorporated herein by reference in its entirety.

### BACKGROUND OF THE INVENTION

Hollow confectionary products are known. Confectionary products have been made that resemble the shape, size or configuration of toys, animals, Christmas characters, Easter eggs and so forth. The core of hollow confections sometimes contains toys.

Chocolate is the material most commonly used to form the “shell” of hollow confections, but other edible materials, such as candy, are also known. In some cases, the chocolate or candy shell is first formed in two or more sections, which are joined. A confection showing a first hollow chocolate body disposed within a second hollow chocolate body has been described where a plastic bag containing a toy or gift can be placed inside the chocolate body. See US 2009/0162493. A process for manufacturing hollow chocolate articles by preforming two shells of chocolate and then joining the two shells together is described in U.S. Pat. No. 3,961,089. Hollow chocolate articles can be made using collapsible balloons as described in U.S. Pat. No. 1,583,839 or by using spin molding as in U.S. Pat. No. 2,796,033. The patents and applications in this paragraph are all incorporated by reference in their entirety into this patent application.

The techniques described above enable manufacture of a simple hollow confection where the outer shell is made of chocolate, and the inner core is empty or contains a non-edible toy. Methods to make an edible three dimensional edible sculpted object that retains it shape and sits inside an outer chocolate shell have not been described.

Marshmallow recipes and methods of manufacture are known. Typically combinations of sugar, water and gelatin are mixed together with air and heated to make a soft confection. The methods described in the following US patents and patent publications have been described: U.S. Pat. No. 2,847,311; U.S. Pat. No. 3,220,853; U.S. Pat. No. 3,607,309; U.S. Pat. No. 3,620,769; U.S. Pat. No. 3,682,659; U.S. Pat. No. 4,189,502; U.S. Pat. No. 5,429,830, U.S. Pat. No. 6,616,963; and US 2004/0142092 are all incorporated by reference herein.

Complex confections with melted, desiccated, discolored or malformed components can be unappealing and even inedible. Until now a manufacturer could not make a complex confection that would allow a consumer to break open a chocolate shell and find the well shaped form of an edible object like an animal, or toy inside. While the use of a mold to make a chocolate shell is known, the use of a mold to make a three-dimensional edible sculpted object and in particular a three-dimensional edible sculpted object made of marshmallow like material is not known.

There is a need for stable complex confections having a three-dimensional edible sculpted object placed in a hollow confection which surrounds the edible object. Such confections and their methods of manufacture are described herein.\

### SUMMARY OF THE INVENTION

The present invention describes novel compositions of complex confections. A complex confection has an outer edible hollow shell and a separate three-dimensional edible sculpted object disposed within the outer shell. The methods to make these confections are also described.

More particularly, the present invention discloses novel complex confectionary products where the outer shell or shells are made of chocolate with an inner edible three-dimensional object, or sculpture, where the inner three-dimensional object and the outer core are made of different materials. As described in one embodiment: a first confection is made that that may be one or more hollow confections, that may comprise a chocolate shell is provided, wherein the chocolate is made of various amounts of the following ingredients: sugar or sugar substitute; cocoa butter, cocoa mass, or cocoa flavoring; milk, whole or skim milk; whole or skim milk powder; one or more emulsifiers and optional flavoring.

A second confection is made that may be; one or more, solid or hollow, confections, that may comprise a three dimensional edible sculpted object, wherein said object is made of marshmallow like ingredients, which may include various amounts of the following: sugar or sugar substitute; glucose, fructose or honey syrup; water; gelatin or pectin; lactic or citric acid; one or more artificial flavors and one or more artificial coloring products.

The first confection contains, in whole or in part, the second confection; which is placed inside one part, usually one half, of the first confection. The second half of the first confection (which contains the second confection) is then joined to the first half of the first confection. After joining the two halves of the first confection (with the second confection inside the first confection) a complex edible confection is created. The complex edible confection is then wrapped and packaged. A method of manufacturing both the first confection, which may a hollow chocolate article, the second confection, which may be a three dimensional edible sculpted object, that may be made of a marshmallow like material, and the joining of the two confections to form a complex edible confection is described and claimed.

### BRIEF DESCRIPTION OF THE FIGURE

FIG. 1 shows a three-dimensional object resembling a chick or duck resting within an outer egg shaped shell.

### DETAILED DESCRIPTION OF THE INVENTION

### Definitions

Unless specifically limited otherwise, the terms used herein have the following definitions.

“C” or “degree C” or “° C.” is temperature according to the Centigrade scale.

“Confection” or “confectionary product” and the like, refers to sweetened food products manufactured for human consumption.

“Chocolate”, refers to an edible product having a taste similar to that of milk chocolate, white chocolate, dark chocolate or any other chocolate variants or substitutes known in the art.

“Complex confection” or “complex candy” and the like, refers to a confection comprised of two or more edible components. The two components are called a “first confection” and a “second confection.” Typically the “first confection” is hollow, and within the hollow first confection will be placed one or more edible three-dimensional sculpted objects herein called the “second confection.” The inner edible three-dimensional sculpted object known as the “second confection” is made of different ingredients than the outer hollow shell known as the “first confection.”

“Duck” or “ducky” and the like, refers to an edible product made to resemble the basic shape, size, color and/or configuration of a common rubber ducky.

“Egg” refers to any edible product made to resemble a round or oval shape. It may be solid or hollow and it may appear as any type of egg such as a bird, chick, or duck, it could be a lizard, Easter or other type of egg. It may be of any dimension, size, shape, color, and/or configuration. Typically it will be the size of a quail, chicken, duck, goose or emu egg and it may be as small as a sparrow's egg or as large as an Ostrich egg. Here an egg may be comprised of multiple first and second components and while typically the first component is hollow and the second is solid, in some cases a first and second component are both solid or both hollow, especially when three or more components are used.

“F” or “degree F” or “F” is temperature according to the Fahrenheit scale.

“First confection” refers to a three-dimensional object that has some type of shell or outer barrier surrounding an inner cavity. In some embodiments the first confection is solid, but typically it has an inner space, core, or cavity that may be empty or more typically the cavity will contain an edible sculpted three-dimensional object. There may be one or more “first confections” nested in side of each other. Typically the “first confection” will have chocolate as a substantial component or it may be made entirely of chocolate.

“Food” or “foodstuff” and the like refers to any edible non-toxic natural or artificial material that is legal and safe to eat.

“Food grade” refers to materials of quality and condition such that they meet minimum standards for use in the manufacture of foodstuffs.

“Marshmallow” or “marshmallow like food” and the like, refers to a category of commonly known confections. These confections typically have a spongy consistency and they may be made of various amounts of sugars, either natural or artificial; glucose, fructose, honey, or molasses syrup; water; gelatin or pectin; lactic, citric or other common consumer acids; and one or more artificial flavors. Typically they are whipped or beaten, often with a gas then cooked or heated to make a stable confection.

“Marshmallow dough” is the composition of marshmallow like mixture before it is heated to form its final shape.

“Second confection” refers to a three-dimensional object that is sculpted into some type of defined shape, appearance or objects, usually solid, that is capable of retaining its shape between the time of manufacture and the time it is consumed. The “second confection” will typically have a spongy consistency and may be made of marshmallow or marshmallow like material.

“Sculpted or “sculpture” describes a defined or recognizable three-dimensional shape. A sculpted confection may be made to have a spongy consistency.

“Sugar” means either a mono-saccharide, such as glucose or a di-saccharide such as sucrose.

“Sugar substitute” means any sweetener that is not sugar.

“Three-dimensional edible sculpted object” means an object is shaped in three dimensions and holds it shape in three dimensions rather the being sculpted and shaped in only two dimensions and simply expanding one of the first two dimensions in size, and it is made of an edible foodstuff.

### Compositions and Products

The present invention describes compositions of matter called complex confections in which the entire confection and all of its components may be edible products and it includes complex confections where a well formed three-dimensional edible sculpted object sits within an outer shell of a product made from different ingredients than the inner sculpted object. The manufacture of these complex confections is also described.

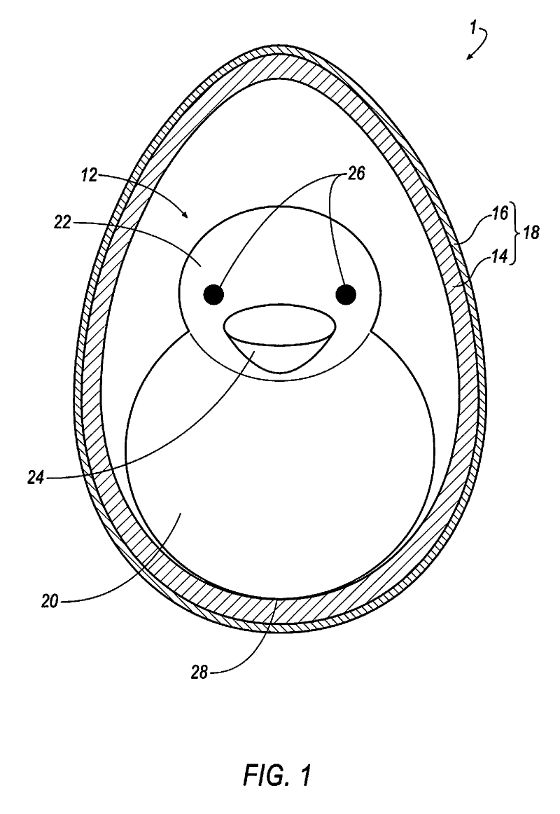

In one embodiment, the invention relates to a complex confection comprising: (a) a first confection comprising a single or multilayered shell and having a cavity within; and (b) a second confection comprising a three-dimensional edible sculpted object, which is placed somewhere within the first confection. The object may be an animal, a toy or anything of interest. The first confection is typically made of chocolate and the second confection made of marshmallow like material. In one embodiment, the invention relates to a complex confection comprising: (a) first confection comprising a chocolate shell formed in the shape of an egg and defining a cavity within; and (b) a second confection comprising a marshmallow confection formed in the shape of an animal wherein the marshmallow confection is disposed within the cavity of the chocolate shell. See FIG. 1, which shows one embodiment of the invention wherein the complex confection 1 comprises a first confection 18 and a second confection 12. The first confection 18 is comprised of an outer shell 18 and the second confection 12 is a three dimensional edible sculpted object 12 that rests within the outer shell of the first confection 18. The second confection 12 is a carefully formed three-dimensional edible sculpted object placed within the first confection 18 to form a finished complex confection 1. In FIG. 1 the sculpted object comprising the second confection 12 is a duck or chick having a lower body 20, an upper head 22, eyes 26 and a beak 24. The second confection 12 rests inside the first confection 18, sitting as shown in FIG. 1 with the base of the chick or duck 28 resting against the inside of the shell of the first confection. The second confection 12 is placed loosely but snugly into the first confection 18 so in one embodiment it is not fixed in a precise location or orientation rather it is allowed to rotate or move about slightly. The second confection 12 is thus placed snugly but freely into the first confection 18 such that empty space inside the first confection 14 is minimized. Upon opening and/or carefully eating the shell of the egg, the ducky 12 inside the egg 18 appears prominent and well formed. The complex confection 1 can be individually wrapped in paper or foil, preferably foil in order to ensure the first confection 18 maintains a solid barrier preventing moisture loss from the first confection. The first confection 18, once individually wrapped can be packaged one or more in a box.

The complex confection 1 may be packaged for sale as an individual unit or two or more units are packaged for sale as a group. Preferably, the group comprises one or three individual units which are typically individually wrapped. The individual wrapping is a protective wrapper, such as in a thin plastic or foil wrapper, that helps to maintain the integrity of the complex confection, and in particular the second confection that rests within the first confection.

In one embodiment, the invention describes a complex confection comprising the following: sugar 38.0%-51.0%; glucose syrup 20.0%-40.0%; water 6.4%-26.4%; gelatin 1.0%-14.0%; lactic acid 1.0%-10.5%; pectin 1.0%-10.38%; citric acid 1.0%-10.30%; artificial flavor 1.0%-10.3%; and cream of tartar 1.00%-10.0%; and optionally artificial colors 0%-10.0%; agar-agar 0%-10.0% and xanthan gum 0%-10.0% and/or comprising the following: sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01% and the marshmallow like material is heated to 100 to 150° F. before being allowed to cool.

In another embodiment, the invention describes a complex confection comprised of the following two components: I) a chocolate shell made from the following ingredients: chocolate material comprised of sugar a) 39.4%-57.1%; and cocoa butter 8.8%-28.8%; and whole milk powder 7.4%-27.4%; cocoa mass 1.4%-21.4%; skimmed milk powder 1.0%-12.0%; emulsifier 0.3%-10.5% and flavoring 0.0%-10.5% and II a sculpted marshmallow inside the chocolate shell, wherein the marshmallow is comprised of: sugar 38.0%-51.0%; glucose syrup 20.0%-40.0%; water 6.4%-26.4%; gelatin 1.0%-14.0%; lactic acid 1.0%-10.5%; pectin 1.0%-10.38%; citric acid 1.0%-10.30%; artificial flavor 1.0%-10.3%; and cream of tartar 1.00%-10.0%; and optionally artificial colors 0%-10.0%; agar-agar 0%-10.0% and xanthan gum 0%-10.0% and/or a confection where the chocolate shell (I) is comprised of sugar 49.4%; cocoa butter 18.8%; whole milk powder 17.4%; cocoa mass 11.4%; skimmed milk powder 2.0%; emulsifier: soya lecithin 0.5%; and flavoring 0.5% and the marshmallow like material forming the sculpture inside the shell is comprised of sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

In some embodiments, the invention describes a complex confection where both white chocolate and brown chocolate in distinct regions comprise the outer shell of the confection.

In other embodiments, the invention describes a complex confection of claim 21 where the outer shell of chocolate appears broken open and the inner three dimensional sculpted object can be seen.

In one embodiment, the invention describes, a composition comprising a complex confection comprising: (a) a chocolate shell resembling an Easter egg and defining a cavity therewithin; and (b) a marshmallow confection resembling a ducky, wherein the marshmallow confection is disposed within the cavity of the chocolate shell.

In a further embodiment, the chocolate shell can be made from the following ingredients, listed in order by weight: sugar; cocoa butter; whole milk powder; cocoa mass; skimmed milk powder; one or more emulsifiers selected from the group comprising soya lecithin, and one or more flavoring products selected from the group comprising vanillin.

In another further embodiment, the marshmallow confection can be made from the following ingredients, listed in order by weight: sugar; glucose syrup; water; gelatin; lactic acid; one or more artificial flavors selected from the group comprising strawberry; corn starch; cream of tartar; one or more artificial coloring products selected from the group comprising FD&C Yellow 5, FD&C Red 40, FD&C Blue 1, and FD&C Yellow 6; agar-agar, and xanthan gum.

The First Confection

The first confection may be comprised of a hollow egg shaped structure that becomes the outer component or shell of a complex confection. It may be the outermost shell; it may have several layers or one of several shells within shells. It may comprise one or more layers. In its preferred embodiment the outer shell is a single layer of chocolate. The process of making the first confection is described in more detail below, here it is noted that the shell is preferably made of two molded components carefully joined after the second confection has been placed inside the two halves. The two sides of the shell are melted and welded to each other such that the finished first component has a uniformly consistent shell that can act as a moisture barrier preventing moisture from escaping and thus ruining the shape, appearance and desirability of the second component. An example of one embodiment is shown in FIG. 1 where the shell 18, is the first confection. In one embodiment the shell is chocolate and made from the following ingredients.

The first confection 18 may be comprised of a chocolate shell which may be made from various amounts of the following ingredients: sugar or sugar substitute; cocoa butter, cocoa mass, or cocoa flavoring; milk, whole or skim milk; whole or skim milk powder; one or more emulsifiers and optional flavoring. The emulsifier may be selected from the group comprising of soya lecithins. The flavoring product may be selected from the group comprising vanillins, real or artificial. When the first confection is made from chocolate the following ingredients may be used.

In one embodiment the following ingredients are used in the following order by weight: sugar; cocoa butter; whole milk powder; cocoa mass; skimmed milk powder; one or more emulsifiers selected from the group comprising soya lecithin, and one or more flavoring products selected from the group comprising vanillin. In certain embodiments the chocolate shell of the first confection is incomplete allowing the second confection to either be seen sitting within the shell of the first confection, i.e. view directly or the first confection may be incomplete such that part of the second confection extends beyond the shell of the first confection.

Applicant now provides a number of specific amounts of the ingredients listed above. It should be understood that some variation in the amounts of each particular ingredient can be tolerated and thus some specific examples and also a range of ingredients is provided. Where the amounts provided here are sometimes approximated, one skilled in the art would be able to make the adjustments needed to have a total of 100 percent of the various compounds. Referring now to the confections where the first ingredient is chocolate the following ranges of ingredients are described. Note there are 5 ingredients and ranges of each ingredient are provided. One should add the amounts for each letter with each ingredient and then adjust as needed to make it total 100%. Thus the “a” ranges for all of the ingredients should be made to total 100%, the “b” ranges, and so on for “c”, “d” and “e.” In one embodiment any commercially available chocolate ingredients may be used to make the chocolate shell of the first confection, in other embodiments the ingredients and ranges provided here are used. Specific examples from each range “a, b, c, d, and e” are provided.

Sugar: a) 39.4%-57.1%; b) 44.4%-53.1%; c) 46.9%-50.6%; d) 48.15%-50.3%; or e) 48.9%-49.6% of the total composition. Cocoa butter: a) 8.8%-28.8%; b) 13.8%-23.8%; c) 16.3%-21.3%; d) 17.55%-20.05%; or e) 18.3%-19.3% of the total composition. Whole milk powder: a) 7.4%-27.4%; b) 12.4%-22.4%; c) 14.9%-19.9%; d) 16.15%-18.65%; or e) 16.9%-17.9% of the total composition. Cocoa mass: a) 1.4%-21.4%; b) 1.4%-21.4%; c) 8.9%-13.9%; d) 10.15%-12.65%; or e) 10.9%-11.9%. Skimmed milk powder: a) 1.0%-12.0%; b) 1.0%-7.0%; c) 1.00%-4.5%; d) 0.75%-3.25%; or e) 1.5%-2.5% of the total composition. An emulsifier: a) 0.3%-10.5%; b) 0.3%-5.5%; c) 0.3%-3.0%; d) 0.3%-2.0%; or e) 0.3%-1.0% of the total composition. And optionally flavoring: a) 0.0%-10.5%; b) 0.2%-5.5%; c) 0.0%-3.0%; d) 0.0%-2.0%; or e) 0.0%-1.0% of the total composition.

An example of a first confection using the “a” ranges above gives the following: sugar a) 39.4%-57.1%; and cocoa butter a) 8.8%-28.8%; and whole milk powder a) 7.4%-27.4%; and cocoa mass a) 1.4%-21.4%; and skimmed milk powder a) 1.0%-12.0% and emulsifier a) 0.3%-10.5% and flavoring a) 0.0%-10.5% and all variations thereof could be used. Similarly the ingredients: sugar, cocoa butter, whole milk powder, cocoa mass, skimmed milk powder, emulsifier and flavoring could be used at the “b-e” ranges and amounts of ingredients provided above, and all variations thereof can also be used.

In some embodiments other types of commercially available cocoa are used.

Specific examples are provided to further illustrate the invention. The invention should not be considered limited to these examples. Examples are provided for each of groupings a-e above. C is for chocolate.

### Example C-1

Sugar 59.4%; cocoa butter 16.3%; whole milk powder 14.9%; cocoa mass 8.9%; and skimmed milk powder 0.5%.

### Example C-2

Sugar 54.4%; cocoa butter 17.55%; whole milk powder 16.15%; cocoa mass 10.15%; skimmed milk powder 0.75%; emulsifier: soya lecithin 0.5%; and flavoring 0.5%.

### Example C-3

Sugar 51.9%; cocoa butter 18.175%; whole milk powder 16.775%; cocoa mass 10.775%; skimmed milk powder 1.375%; emulsifier: soya lecithin 0.5%; and flavoring 0.5%.

### Example C-4

Sugar 50.65%; cocoa butter 18.4875%; whole milk powder 17.0875%; cocoa mass 11.0875%; skimmed milk powder 1.6875%; emulsifier: soya lecithin 0.5%; and flavoring 0.5%.

### Example C-5

Sugar 49.9%; cocoa butter 18.675%; whole milk powder 17.275%; cocoa mass 11.275%; skimmed milk powder 1.875%; emulsifier: soya lecithin 0.5%; and flavoring 0.5%.

### Example C-6

Sugar 49.4%; cocoa butter 18.8%; whole milk powder 17.4%; cocoa mass 11.4%; skimmed milk powder 2.0%; emulsifier: soya lecithin 0.5%; and flavoring 0.5%.

### Example C-7

Sugar 48.9%; cocoa butter 18.925%; whole milk powder 17.525%; cocoa mass 11.525%; skimmed milk powder 2.125%; emulsifier: soya lecithin 0.5%; and flavoring 0.5%.

### Example C-8

Sugar 48.15%; cocoa butter 19.1125%; whole milk powder 17.7125%; cocoa mass 11.7125%; skimmed milk powder 2.3125%; emulsifier: soya lecithin 0.5%; and flavoring 0.5%.

### Example C-9

Sugar 46.9%; cocoa butter 19.425%; whole milk powder 18.025%; cocoa mass 12.025%; skimmed milk powder 2.625%; emulsifier: soya lecithin 0.5%; and flavoring 0.5%.

### Example C-10

Sugar 44.4%; cocoa butter 20.05%; whole milk powder 18.65%; cocoa mass 12.65%; skimmed milk powder 3.25%; emulsifier: soya lecithin 0.5%; and flavoring 0.5%.

### Example C-11

Sugar 39.4%; cocoa butter 21.3%; whole milk powder 19.9%; cocoa mass 13.9%; skimmed milk powder 4.5%; emulsifier: soya lecithin 0.5%; and flavoring 0.5%.

Many different methods may be used to form the shell of the first confection. Here we disclose a method which provides excellent results. The confection is described below first, followed by the process of manufacture.

The size and shape of the first and second confection can vary widely, but most typically the first confection will be from about 0.5 to 5.0 cm wide, and about 0.5 to about 7.0 cm long, or from about 1.0 to 4.0 cm wide, and about 1.5 to about 6.0 cm long, or from about 1.0 to 3.0 cm wide, and about 1.5 to about 3.5 cm long, or from about 1.5 to 2 cm wide, and about 2.0 to about 3.0 cm long. A preferred embodiment is about 1.85 cm in width and about 2.6 cm in length. When the width is about 1.85 cm the corresponding circumference is about 15 cm. When the length is about 2.6 cm the corresponding circumference is about 18.2 cm.

When appropriate adjustments are made to the manufacturing process the size of the shell can range from smaller than a sparrow's egg to as large or larger than an ostrich egg. It can be intact or open as if broken by a chick. The size of the shell can be selected based on preferences of the consumer, as well as practical constraints imposed by packaging, shipping or displaying the finished product. In a preferred embodiment the second confection fits snugly and completely within the outer layer or shell of the first confection. The snug fit of the second confection inside the first confection is important in the preferred embodiment as a loose fitting second confection can cause a rupture in the chocolate seal between the two sides of the chocolate, which can lead to moisture lose of the second confection resulting in an unappealing, hard and hard to chew second confection. In other embodiments the first confection does not fully contain the second confection but the second confection is still retained snugly or tightly within the first confection. In certain embodiments, the first confection is made to resemble the shape of a hollow object such as a ball, an oval, a sphere, an egg, or an Easter egg. The preferred first confection is hollow, made of chocolate and in the form of a bird egg.

The weight of the first confection will vary according to the shell dimensions, the thickness of the shell walls, and the finished density of the chocolate or candy material used therein, as well as the weight of the second confection. When the first confection is made from chocolate, the thickness of the shell walls may preferably be in the range from 0.05 to 10 millimeters (mm); from 0.01 to 5 mm, from 0.1 to 4 mm; from 0.2 to 3 mm, from 0.5 to 2.5 mm or about 2 mm. Preferably, the thickness of chocolate shell walls is in the range of 1 to 3 mm when the egg is about 1.85 cm in width and about 2.6 cm in length.

The ingredients of the first confection may vary; they may be comprised of any edible ingredients. In the preferred embodiment the first confection 18 is preferably made of chocolate.

The Second Confection

The second confection may be comprised of a sculpted edible material that is capable of holding a defined shape. It may be any foodstuff that is firm and capable of being molded or sculpted. An example of one embodiment is shown in FIG. 1 where a sculpted object 12 rests within the cavity of the first confection 18. The sculpted object 12, is a chick or ducky, having a lower body 20, an upper head 22, eyes 26 and a beak 24.

In one embodiment the second confection may be comprised of a marshmallow like material which can be comprised of various amounts of the following ingredients: sugar or sugar substitute; glucose, fructose or honey syrup; water; gelatin or pectin; lactic or citric acid; one or more artificial flavors and one or more artificial coloring products.

In one embodiment the second confection is made from the following ingredients, listed in order by weight: sugar; glucose syrup; water; gelatin; lactic acid; one or more artificial flavors selected from the group comprising strawberry; corn starch; cream of tartar; one or more artificial coloring products selected from the group comprising FD&C Yellow 5, FD&C Red 40, FD&C Blue 1, and FD&C Yellow 6; agar-agar, and xanthan gum.

Applicant provides both ranges of, and specific amounts of, the ingredients listed above. One skilled in the art will understand that some variation in the amounts of each particular ingredient can be tolerated and thus some specific examples and also a range of ingredients are provided. Where the amounts provided here are sometimes approximated, one skilled in the art would be able to make the adjustments needed to have a total of 100 percent of the various compounds. Referring now to the second confections where it is made of marshmallow like ingredients; 12 ingredients are described, in one embodiment 9 ingredients are used in other embodiment 3 optional ingredients are also described and often used. To determine the amount of each ingredient to use, add the amounts for each letter with each ingredient, thus the “a” ranges for all of the ingredients and then adjust to make the total 100%. The amounts for each range “a-e” of each ingredient should be adjusted to total 100%. Specific examples from each range “a-e” are provided.

Sugar a) 38.0%-51.0%; b) 43.0%-48.0%; c) 45.0%-50.0%; d) 46.0%-50.0%; or e) 47.0%-48.0% of the total composition. Glucose syrup a) 20.0%-40.0%; b) 25.0%-35.0%; c) 28.0%-33.0%; d) 29.0%-31.5%; or e) 30.0%-31.0 of the total composition. Water a) 6.4%-26.4%; b) 11.5%-21.5%; c) 14.0%-19.0%; d) 15.0%-17.5%; or e) 16.0%-17.0% of the total composition. Gelatin a) 1.0%-14.0%; b) 1.0%-9.00%; c) 1.5%-5.5%; d) 3.0%-5.5%; or e) 3.5%-4.5% of the total composition. Lactic acid a) 1.0%-10.5%; b) 1.0%-5.5%; c) 1.0%-3.0%; d) 0.5%-2.0%; or e) 0.2%-1.0% of the total composition. Pectin a) 1.0%-10.38%; b) 1.0%-5.38%; c) 1.0%-2.88%; d) 0.50%-1.63%; or e) 0.50%-0.88% of the total composition. Citric acid a) 1.0%-10.30%; b) 1.00%-5.30%; c) 0.50%-2.8%; d) 0.50%-1.55%; or e) 0.50%-0.80% of the total composition. Artificial flavor a) 1.0%-10.3%; b) 1.0%-5.3%; c) 0.5%-2.7%; d) 0.5%-1.5%; or e) 0.2%-0.8% of the total composition. Cream of tartar a) 1.00%-10.0%; 0.5%-5.0%; 0.5%-2.5%; 0.25%-1.3%; or 0.20%-0.6% of the total composition.

The following ingredients are optional, but if used the following amounts are recommended. Artificial colors a) 0%-10.0%; 0%-5.0%; 0%-2.5%; 0%-1.25%; or 0%-0.5% of the total composition. Agar-agar a) 0%-10.0%; 0%-5.0%; 0%-2.5%; 0%-1.3%; or 0%-0.5% of the total composition. Xanthan gum a) 0%-10.0%; 0%-5.0%; 0%-2.5%; 0%-1.25%; or 0%-0.5% of the total composition.

An example of a second confection using the “a” ranges above gives the following: sugar a) 38.0%-51.0%; glucose syrup a) 20.0%-40.0%; water a) 6.4%-26.4%; gelatin a) 1.0%-14.0%; lactic acid a) 1.0%-10.5%; pectin a) 1.0%-10.38%; citric acid a) 1.0%-10.30%; artificial flavor a) 1.0%-10.3%; and cream of tartar a) 1.00%-10.0%; and optionally artificial colors a) 0%-10.0%; agar-agar a) 0%-10.0% and xanthan gum a) 0%-10.0%, and all the variations with all the possible combinations could be used. Similarly the ingredients: sugar, glucose syrup, water, gelatin, lactic acid, pectin, citric acid, artificial flavor, cream of tartar, artificial colors, agar-agar and xanthan gum can be used with the amounts of ingredients provided in the “b-e” embodiments and example amounts in the ranges provided above and all variations thereof can also be used.

Specific examples are provided to further illustrate the invention. The invention should not be considered limited to these examples. Examples are provided for each of groupings a-e above. M is for marshmallow.

### Example M-1

Sugar 55.22%; glucose syrup 27.74%; water 13.85%; gelatin 1.5%; lactic 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-2

Sugar 51.5%; glucose syrup 29.0%; water 15.0%; gelatin 2.75%; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-3

Sugar 49.6%; glucose syrup 29.6%; water 15.7%; gelatin 3.38%; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-4

Sugar 48.97%; glucose syrup 29.9275%; water 16.0375%; gelatin 3.6875%; lactic acid 0.1075%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-5

Sugar 48.22%; glucose syrup 30.12%; water 16.225%; gelatin 3. 875%; lactic acid 0.295%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-6

Sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-7

Sugar 47.22%; glucose syrup 30.37%; water 16.48%; gelatin 4.13%; lactic acid 0.55%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-8

Sugar 46.47%; glucose syrup 30.56%; water 16.6625%; gelatin 4.3125%; lactic acid 0.7325%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-9

Sugar 45.22%; glucose syrup 30.87%; water 16.98%; gelatin 4.63%; lactic acid 1.05%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-10

Sugar 42.72%; glucose syrup 31.49%; water 17.60%; gelatin 5.25%; lactic acid 1.67%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

### Example M-11

Sugar 37.72%; glucose syrup 32.74%; water 18.85%; gelatin 6.5%; lactic acid 2.92%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

The second confection can be made to resemble an animal, such as a duck, baby duck or ducky; a chick, baby chicken or chicky; a baby rabbit or bunny; dog, puppy, cat, kitten, or it could be made in the shape of any toy, such as a toy soldier, a Russian doll, an action figure or any other desired shape. The size of the preferred second confection 12 is determined by creating a confection small enough to fit inside of the first confection 18. The size and shape must be precisely defined, with relatively low tolerance, such that the second confection fits snugly and comfortably within the first confection 18 but without being squished or mashed or pushed into the first confection 18 such that the appearance of the first confection is damaged, and yet the second confection must also be large enough that it fills much of the empty space 14 of the first confection 18, so that it fits snugly within the first confection, so as to further reduce any possible damage to the first confection.

Embodiments of a complex confection made by the processes disclosed herein are also described where the second confection extends beyond or outside the shell 18 of the first confection 18.

A preferred embodiment of the second confection is where the ingredients of the sculpture are selected from marshmallow like material which is then formed into the shape of a duck, baby duck or ducky 18; a chick or baby chicken or a combination of both and preferably having black eyes 26 and an orange beak 24, and preferably made with a mold.

### Method of Manufacture

The present invention describes a process for manufacturing a complex confection. It should be recognized that heat, humidity and/or mechanical stresses are involved in the manufacture, production, packaging, shipping, storage and delivery of products of this type and any one or all of these factors can contribute to the failure of a stable complex confectionary products. Special care must be taken in the manufacture of a complex confection, the outer component and the inner component or components can be subject to melting, desiccation, discoloration or malformation. Often, this problem is exacerbated if the products are exposed to high or low temperature or humidity during or after the manufacturing process, especially during storage, shipping and handling. The special ingredients used and the design and execution of the methods of manufacture disclosed herein will reduce the failure rate of the manufacture of complex edible confections.

In one embodiment, the present invention describes a process for manufacturing a complex confection, wherein all the components of the confection are edible; the process comprising the steps of: (a) forming a first confection, wherein the first confection is hollow and comprises an outer shell and an inner core defined by the outer shell; (b) forming a second confection; (c) placing the second confection inside the inner core of the first confection; and (d) sealing the first confection to completely enclose and second confection and form a complex confection.

In some embodiments, the invention describes a process for manufacturing a complex confection, wherein the first confection has the shape of a ball, oval, or egg and/or the second confection has the shape of a baby duck or chicken and/or the first confection is made from chocolate and/or the second confection is made of marshmallow like ingredients.

In some further embodiments, the invention describes a process for manufacturing a complex confection, wherein the chocolate material comprises the following ingredients: sugar or sugar substitute; cocoa, whole or skim milk or milk powder; one or more emulsifiers and a flavoring ingredient and/or wherein the chocolate material comprises the following ingredients, listed in order by weight: sugar; cocoa butter; whole milk powder; cocoa mass; skimmed milk powder; one or more emulsifiers selected from the group comprising soya lecithin, and one or more flavoring products selected from the group comprising vanillin.

In yet another embodiment, the invention describes a process for manufacturing a complex confection wherein the chocolate material comprises the following ingredients, sugar a) 39.4%-57.1%; and cocoa butter 8.8%-28.8%; and whole milk powder 7.4%-27.4%; cocoa mass 1.4%-21.4%; skimmed milk powder 1.0%-12.0%; emulsifier 0.3%-10.5% and flavoring 0.0%-10.5% and/or wherein the chocolate material comprises the following ingredients, sugar 49.4%; cocoa butter 18.8%; whole milk powder 17.4%; cocoa mass 11.4%; skimmed milk powder 2.0%; emulsifier: soya lecithin 0.5%; and flavoring 0.5%.

In another embodiment, the invention describes a process for manufacturing a complex confection, wherein the marshmallow material comprises the following ingredients, listed in order by weight: sugar or sugar substitute; glucose or fructose syrup; water; gelatin or pectin; lactic or citric acid; one or more artificial flavors and one or more artificial coloring products and/or wherein the marshmallow material comprises the following ingredients, listed in order by weight: sugar; glucose syrup; water; gelatin; lactic acid; one or more artificial flavors selected from the group comprising strawberry; corn starch; cream of tartar; one or more artificial coloring products selected from the group comprising FD&C Yellow 5, FD&C Red 40, FD&C Blue 1, and FD&C Yellow 6; agar-agar, and xanthan gum.

In one embodiment, the invention describes a process for manufacturing a complex confection, wherein the ranges of ingredients adjusted to 100% are: sugar 38.0%-51.0%; glucose syrup 20.0%-40.0%; water 6.4%-26.4%; gelatin 1.0%-14.0%; lactic acid 1.0%-10.5%; pectin 1.0%-10.38%; citric acid 1.0%-10.30%; artificial flavor 1.0%-10.3%; and cream of tartar 1.00%-10.0%; and optionally artificial colors 0%-10.0%; agar-agar 0%-10.0% and xanthan gum 0%-10.0%.

In another embodiment, the invention describes a process for manufacturing a complex confection, wherein the marshmallow material is comprised of sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

In one embodiment, the invention describes a process for making a marshmallow like material comprising the following steps: a) mixing the following ingredients, listed in order by weight: sugar; glucose syrup; water; gelatin; lactic acid; one or more artificial flavors selected from the group comprising strawberry; corn starch; cream of tartar; one or more artificial coloring products selected from the group comprising FD&C Yellow 5, FD&C Red 40, FD&C Blue 1, and FD&C Yellow 6; agar-agar, and xanthan gum; b) injecting the mixed ingredients of step a into a mold; c) heating the mold to cook and activate the ingredients forming a three-dimensional edible sculpted object; d) cooling the mold and removing the three-dimensional edible sculpted object; e) optionally treating the three-dimensional edible sculpted object with powdered starch or sugar.

In a further embodiment, the invention describes a process for making a marshmallow like material wherein the ingredients are adjusted to 100% in various combinations of the following: sugar 38.0%-51.0%; glucose syrup 20.0%-40.0%; water 6.4%-26.4%; gelatin 1.0%-14.0%; lactic acid 1.0%-10.5%; pectin 1.0%-10.38%; citric acid 1.0%-10.30%; artificial flavor 1.0%-10.3%; and cream of tartar 1.00%-10.0%; and optionally artificial colors 0%-10.0%; agar-agar 0%-10.0% and xanthan gum 0%-10.0%. and/or wherein the marshmallow material is comprised of sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01% and the marshmallow like material is heated to 100 to 150° F. before being allowed to cool.

In one embodiment, the invention describes a process comprising forming a first confection, a second confection and placing the second confection within the inner core of the first confection. See FIG. 1, which shows one embodiment of the invention wherein the complex confection 1 has a first confection 18 comprising a single shell 18, that is formed of two half shells made of chocolate. A second confection 12 is placed into one of the half shells of the first confection. The second confection 12 is a three-dimensional edible sculpted object. Once the second confection is carefully placed inside the cavity 14 of the first confection 18, the second half of the shell is used to enclose the second confection inside the first confection. The two half shells of the first confection are sealed to make a single shell 18 that is resistant to moisture exchange. The sealed shell is further protected with a flexible cover or wrapping. The preferred wrapping material is thin metal foil such as food grade aluminum foil.

Manufacture of the First Confection and Joining of the Two Parts of the First Confection

Various procedures for making hollow shells of chocolate are known. See for example the following US patents and patent publications; all incorporated by reference herein. US 2009/0162493; U.S. Pat. No. 3,961,089; U.S. Pat. No. 1,583,839; and U.S. Pat. No. 2,796,033. Here we disclose a new and preferred method of making a chocolate shell when used to enclose an edible marshmallow sculpted object.

Chocolate is melted to a temperature of between about 78 to 100 degrees F. An amount of the melted chocolate useful to create half of a shell as described herein is deposited into a mold. The mold is preferably made of food grade polycarbonate. The mold is also at a temperature of about 78° to about 100° F. or to a temperature that melts the chocolate and it transitions to a liquid or syrup consistency. The chocolate melt is deposited into the mold and then the mold is shaken, vibrated, tilted and moved in a manner to evenly move and distribute an even layer of chocolate over the mold. After the chocolate is evenly dispersed in the mold the temperature of the mold is lowered and the mold is cooled to about 40-60 degrees F. or as needed to solidify the chocolate. The solidified chocolate in the molds are then placed into position to receive the formed marshmallow sculpted edible figures. The formed marshmallow sculpted edible figures are placed snugly and in the proper position into the half shell of the first confection. The remaining half shell of the first confection is placed against the edge of the first half shell and positioned for joining with the first half shell which now contains the formed marshmallow sculpted edible figure. The two half shells, one with figure nested inside, one without, are brought together such that there is complete contact, chocolate to chocolate, over all of the two edges of the two half shells. This joining of the two half shells is accomplished as the temperature is quickly raised room temperature to a higher temperature. Initially from about 40° F. to about 60° F. and then the two half shells, briefly at about 100° F. are in contact over all of their previously exposed edges when they are exposed to directed heat which melts the two sides of the shells together thus forming a continuous weld of solid chocolate egg shell 18, which, after the brief exposure to the directed heat, is cooled, creating a first confection, which now holds the second confection inside of its cavity, wherein the shell is solid chocolate and highly resistant to any exchange of moisture. Moisture exchange or moisture escape from the marshmallow like second confection, can ruin the taste and appearance of the three-dimensional marshmallow sculpture. The methods described herein prevent the decay and collapse of the three-dimensional marshmallow sculpture.

The use of the selective directed heat which melts and allows the reforming of the two chocolate shells into one single uniform chocolate shell with a single layer can be accomplished with many different types of heating sources that allow for directed heat. The duration of the directed heat should be short, on the order of 20 seconds or less, depending on the temperature used and the ambient conditions. In one embodiment electrically conductive wires are used to melt the two sides of the egg, wherein the wires are placed along side of a assembly belt which moves a chocolate egg between the two wires, exposing the egg to the heat from the wires for about 5-15, or 8-12, or about 10 seconds of heat. The heated wires can be of various thicknesses, again depending on the amount of heat produced and how directed, but wires with a thickness of about 1 to 5 mm, preferably about 3 mm in thickness work well.

Use of radiant heat from other sources other than electrically conductive wires are may also be used. Use of directed convention heat, for example using warmed air could also be used to join the chocolate shells.

Manufacture of the Second Confection

The three-dimensional edible sculpted object made of marshmallow like material is preferably made starting with a food grade polycarbonate mold. A food grade polycarbonate mold is one method used to create a solid three-dimensional edible sculpted marshmallow which has heretofore never been used with any measure of commercial success. Problems develop when making a delicate three dimensional object made of sculpted special marshmallow. These problems are compounded when the sculpted marshmallow is the second confection of a complex confection where the first confection is a chocolate shell. The second confection cannot simply be made from the same starting materials as many marshmallow like foodstuffs. Unlike other marshmallow like foods, the processes disclosed here result in a confection that is able to retain its three dimensional shape, even under the harsh conditions that are frequently encountered during manufacture, packaging, storage and shipping and more surprisingly even when the three-dimensional sculpture is enclosed in nothing more than a chocolate egg. Most marshmallow is not capable of holding three dimensional shape. The marshmallow like ingredients disclosed herein can accomplish this feat. Marshmallow is typically made by starting with the ingredients used to make the product, mixing or blending the ingredients together to make marshmallow dough which is then further processed. The marshmallow dough may be whipped or beaten and frequently has gas added, usually the gas is air or nitrogen, and the gas is added during the mixing or beating process and under a pressure of 50 to 300 p.s.i. as needed depending on the consistency and temperature of the dough and final product that is being made.

Accordingly, the product of this invention depends in part on the amount of the various ingredients used, the relation of the ingredients to one another, the degree of beating, the amount of air incorporated and other processing conditions. Because of the inter-relation of these various factors. It will be understood that one factor can be changed to compensate for a variation in another factor to provide the desirable features of this invention.

Typically the marshmallow dough is pumped through a nozzle and then discharged at a temperature above 100 but below 150 degrees F. The product is cooled and then the discharge bead is treated with a powder like sugar, starch or combination of the two to aid cutting. Following cutting, the product is usually cured and tumbled or worked to provide a uniform shaped product that is free from distortion, tails and sticking. We call marshmallow products of this type, two dimensional to distinguish them from the unique molded marshmallow products we can make. Marshmallow products of this type, while technically having three-dimensions are really more like a two dimensional image as opposed to the three dimensional sculpted object. When a “cookie cutter” type cutter is dropped properly on a bead of marshmallow dough that cuts it, it forms what is essentially a “thick picture” of a two dimensional object. But the thickness dimension of these objects in fact have no features at all, all the features are expressed in only two dimensions. Applicant's creation can be easily contrasted with “thick two dimensional” creations. Previous marshmallow creations were three dimensional only in the technical sense that they are a little more than flat objects but in fact they did not have three shaped dimensions, only two.

Here the ingredients from the composition section above are mixed with gas to produce marshmallow dough having a foam consistency. Then an aliquot of this material here called “marshmallow dough” is placed into a polycarbonate mold. This can be done at room temperature. The temperature is briefly raised to above 100 but below 150 degrees F., and then lowered to about 73-74° F. The process is carefully controlled so that the humidity is maintained at about 45% relative humidity. Artificial coloring, flavoring curing and if desired, treated with a powder like sugar or starch to maintain the shape and appearance of the three-dimensional edible sculpted object may be used.

Here we describe a unique marshmallow recipe but the basic techniques and other recipes for making marshmallow like materials for marshmallow like foods is known and many of those techniques can be used here, although the special ingredients provided herein are much preferred. Preferably, the second confection is made into a three-dimensional sculpted marshmallow like material. The methods described in the following US patents and patent publications are known in the art U.S. Pat. No. 2,847,311; U.S. Pat. No. 3,220,853; U.S. Pat. No. 3,607,309; U.S. Pat. No. 3,620,769; U.S. Pat. No. 3,682,659; U.S. Pat. No. 4,189,502; U.S. Pat. No. 5,429,830, U.S. Pat. No. 6,616,963; and US 2004/0142092 are all incorporated by reference herein. These known methods are modified by selective use and application of selective amounts and type of sugar, syrup, water, gelatin and edible acids such as lactic and citric acid which are incorporated with the use of food grade molds to achieve a three dimensional foodstuff that has the desired appearance. Commonly used colorants and those used in the examples provided are: FD&C Yellow 5, FD&C Red 40, FD&C Blue 1, and FD&C Yellow 6.

Completing the Complex Confection.

The procedures above describe the composition and manufacture of the first and second confection and how the two halves of the first confection are joined together and sealed with the second confection sealed inside of the first confection thus forming a complex confection comprising the first confection surrounding the second confection.

Once the second confection is placed snugly into one of the two shells of the first confection the first half of the first confection is placed down on a moving platform or belt with the second confection placed in the first half of the first confection and then the second half of the first confection, is carefully placed on top of the first half of the first confection. Once the two shells are placed together such that their exposed edges are resting against each other with second confection inside the chamber formed from the two shells, the shells are exposed to directed heat of about 78 to 100° F. degrees for about 17 seconds. The exposure to the directed heat is accomplished by placing the confection on a moving belt wherein the eggs are moved between heated wires such that the eggs are briefly exposed to the melting temperature for about 5-15, 8-12, or 10 seconds or so with the heat sufficient to melt the edge of the confection. If the first confection is chocolate then it takes about 80 to 100° F., for 5-13 seconds, to melt or weld the two chocolate halves together and then the shells are allowed to cool. The precision melting welds the two shells together and forms a moisture barrier which protects the second confection. The complex confection is then wrapped with a thin layer of foil that is standard for the industry. The wrapped eggs are then packaged either one or three to a box for shipping and delivery.

After joining the two halves of the first confection to form a void within which the second confection is held, the complex confection has an appearance similar to FIG. 1 wherein the first confection 18 surrounds the second confection 12 which sits snugly and completely within the cavity 14 of the first confection 18. Desired color schemes can be achieved using food coloring agents and additives that are known in the art.

We use the example of a marshmallow ducky put inside a chocolate shell, below but other materials could also be used and they would be apparent to one of skill in the art. The examples below provide further details and descriptions but they are examples only and should not be taken to limit the scope of the claims or the invention in any manner.

### EXAMPLES

In order that the present invention may be more readily understood, a specific embodiments or example will now be described.

### Example 1

A mold for the first confection is first prepared in the traditional manner of making molds. The first mold is made in the shape of an egg. The mold is made of food grade polycarbonate. The first mold is made in 2 parts, one half for one side of the egg and another half for the other side. The two sides are symmetrical and will later be joined. A separate mold is needed for the second confection and that is described below. The first confection is made of chocolate using the following ingredients. Sugar 49.4%; cocoa butter 18.8%; whole milk powder 17.4%; cocoa mass 11.4%; skimmed milk powder 2.0%; emulsifier: soya lecithin 0.5%; and flavoring 0.5%.

An appropriate amount of chocolate is obtained and warmed to about 80° F. and then poured into each of two sides or two halves of food grade polycarbonate mold which has an egg shell appearance whose dimensions are about 1.85 cm wide by 2.6 cm long. The two shells of the first confection now coated with chocolate are then shaken and vibrated such that the entire shell has a nice appropriately thick layer of chocolate, in this example it is about 2-3 mm thick and then the chocolate in the molds are cooled to about 50 degrees F. The second confection having been made separately is then secured and placed into one of the two sides of the egg mold.

The second confection is made using a food grade polycarbonate mold, having two sides placed together with a marshmallow like material inside and then heated to form the marshmallow. The other procedures being described as above. The marshmallow like material in this example is made from the following types and amounts of ingredients. Sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

Once the second confection is placed snugly into one of the two shells of the first confection the first half of the first confection is placed down on a moving platform with the second confection placed in the first half of the first confection and then the second half of the first confection, in this example the other half of the chocolate shell is carefully placed on top of the first half of the first chocolate shell with has the first confection ducky in the shell. This placed the two halves of the chocolate shell of the first confection so they fit snugly and uniformly against each other. Once the two shells are placed together such that their exposed edges are resting against each other with second confection ducky inside the chamber formed from the two shells, the shells are exposed to directed heat of about 78 to 100° F. degrees for about 17 seconds. The exposure to the directed heat is accomplished by placing the eggs on a moving belt wherein the eggs are moved between heated wires such that the eggs are briefly exposed to the melting temperature for about 17 seconds and then they are allowed to cool. The precision melting welds the two shells together and forms a moisture barrier which protects the second confection. The complex confection is then wrapped with a thin layer of foil that is standard for the industry. The wrapped eggs are then packaged either one or three to a box for shipping and delivery.

After joining the two halves of the first confection to form a void within which the second confection is held, the complex confection has an appearance similar to FIG. 1 wherein the first confection 18 surrounds the second confection 12 which sits snugly and completely within the cavity 14 of the first confection 18. The second confection 12 resembles a ducky sitting upright inside a chocolate egg. In this example the second confection 12 ducky has a lower body 20, a head 22, a beak 24 and two eyes 26. In a preferred embodiment the body 20 and head 22 are colored yellow, the beak 24 is orange and the eyes 26 are black. Desired color schemes can be achieved using food coloring agents and additives that are known in the art.

We claim:

1. A process for manufacturing a complex confection, wherein all the components of the confection are edible; the process comprising the steps of:
(a) forming a first confection, wherein the first confection is hollow and comprises an outer shell and an inner core defined by the outer shell;
(b) forming a second confection;
(c) placing the second confection inside the inner core of the first confection; and
(d) sealing the first confection to completely enclose and second confection and form a complex confection.

2. The process of claim 1, wherein the first confection has the shape of a ball, oval, or egg.

3. The process of claim 2, wherein the second confection has the shape of a baby duck or chicken.

4. The process of claim 3, wherein the first confection is made from chocolate.

5. The process of claim 4, wherein the second confection is made marshmallow like ingredients.

6. The process of claim 5, wherein the chocolate material comprises the following ingredients: sugar or sugar substitute; cocoa, whole or skim milk or milk powder; one or more emulsifiers and a flavoring ingredient.

7. The process of claim 6, wherein the chocolate material comprises the following ingredients, listed in order by weight: sugar; cocoa butter; whole milk powder; cocoa mass; skimmed milk powder; one or more emulsifiers selected from the group comprising soya lecithin, and one or more flavoring products selected from the group comprising vanillin.

8. The process of claim 7, wherein the chocolate material comprises the following ingredients, sugar a) 39.4%-57.1%; and cocoa butter 8.8%-28.8%; and whole milk powder 7.4%-27.4%; cocoa mass 1.4%-21.4%; skimmed milk powder 1.0%-12.0%; emulsifier 0.3%-10.5% and flavoring 0.0%-10.5%.

9. The process of claim 8, wherein the chocolate material comprises the following ingredients, sugar 49.4%; cocoa butter 18.8%; whole milk powder 17.4%; cocoa mass 11.4%; skimmed milk powder 2.0%; emulsifier: soya lecithin 0.5%; and flavoring 0.5%.

10. The process of claim 9, wherein the marshmallow material comprises the following ingredients, listed in order by weight: sugar or sugar substitute; glucose or fructose syrup; water; gelatin or pectin; lactic or citric acid; one or more artificial flavors and one or more artificial coloring products.

11. The process of claim 10, wherein the marshmallow material comprises the following ingredients, listed in order by weight: sugar; glucose syrup; water; gelatin; lactic acid; one or more artificial flavors selected from the group comprising strawberry; corn starch; cream of tartar; one or more artificial coloring products selected from the group comprising FD&C Yellow 5, FD&C Red 40, FD&C Blue 1, and FD&C Yellow 6; agar-agar, and xanthan gum.

12. The process of claim 11, wherein the ranges of ingredients adjusted to 100%. are: sugar 38.0%-51.0%; glucose syrup 20.0%-40.0%; water 6.4%-26.4%; gelatin 1.0%-14.0%; lactic acid 1.0%40.5%; pectin 1.0%-10.38%; citric acid 1.0%-10.30%; artificial flavor 1.0%-10.3%; and cream of tartar 1.00%-10.0%; and optionally artificial colors 0%-10.0%; agar-agar 0%-10.0% and xanthan gum 0%-10.0%.

13. The process of claim 12, wherein the marshmallow material is comprised of sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

14. (canceled)

15. A process for making a marshmallow like material comprising the following steps:
a) mixing the following ingredients, listed in order by weight: sugar; glucose syrup; water; gelatin; lactic acid; one or more artificial flavors selected from the group comprising strawberry; corn starch; cream of tartar; one or more artificial coloring products selected from the group comprising FD&C Yellow 5, FD&C Red 40, FD&C Blue 1, and FD&C Yellow 6; agar-agar, and xanthan gum;
b) injecting the mixed ingredients of step a into a mold;
c) heating the mold to cook and activate the ingredients forming a three-dimensional edible sculpted object;
d) cooling the mold and removing the three-dimensional edible sculpted object;
e) optionally treating the three-dimensional edible sculpted object with powdered starch or sugar.

16. The process of claim 15 wherein the ingredients are adjusted to 100% in various combinations of the following: sugar 38.0%-51.0%; glucose syrup 20.0%-40.0%; water 6.4%-26.4%; gelatin 1.0%-14.0%; lactic acid 1.0%40.5%; pectin 1.0%-10.38%; citric acid 1.0%-10.30%; artificial flavor 1.0%-10.3%; and cream of tartar 1.00%-10.0%; and optionally artificial colors 0%40.0%; agar-agar 0%-10.0% and xanthan gum 0%-10.0%.

17. The process of claim 16, wherein the marshmallow material is comprised of sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01% and the marshmallow like material is heated to 100 to 1501 before being allowed to cool.

18. A confection comprising the following: sugar 38.0%-51.0%; glucose syrup 20.0%-40.0%; water 6.4%-26.4%; gelatin 1.0%-14.0%; lactic acid 1.0%-10.5%; pectin 1.0%-10.38%; citric acid 1.0%-10.30%; artificial flavor 1.0%-10.3%; and cream of tartar 1.00%-10.0%; and optionally artificial colors 0%-10.0%; agar-agar 0%-10.0% and xanthan gum 0%-10.0%.

19. A confection of claim 18 comprising the following: sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01% and the marshmallow like material is heated to 100 to 150° F. before being allowed to cool.

20. A complex confection comprised of the following two components: I) a chocolate shell made from the following ingredients: chocolate material comprised of sugar a) 39.4%-57.1%; and cocoa butter 8.8%-28.8%; and whole milk powder 7.4%-27.4%; cocoa mass 1.4%-21.4%; skimmed milk powder 1.0%-12.0%; emulsifier 0.3%-10.5% and flavoring 0.0%-10.5% and II a sculpted marshmallow inside the chocolate shell, wherein the marshmallow is comprised of: sugar 38.0%-51.0%; glucose syrup 20.0%-40.0%; water 6.4%-26.4%; gelatin 1.0%-14.0%; lactic acid 1.0%-10.5%; pectin 1.0%-10.38%; citric acid 1.0%-10.30%; artificial flavor 1.0%-10.3%; and cream of tartar 1.00%-10.0%; and optionally artificial colors 0%-10.0%; agar-agar 0%-10.0% and xanthan gum 0%-10.0%.

21. A confection of claim 20 where the chocolate shell (I) is comprised of sugar 49.4%; cocoa butter 18.8%; whole milk powder 17.4%; cocoa mass 11.4%; skimmed milk powder 2.0%; emulsifier: soya lecithin 0.5%; and flavoring 0.5% and the marshmallow like material forming the sculpture inside the shell is comprised of sugar 47.72%; glucose syrup 30.24%; water 16.35%; gelatin 4.00. %; lactic acid 0.42%; pectin 0.38%; citric acid 0.30%; artificial flavor 0.27%; cornstarch 0.20%; cream of tartar 0.06%; artificial colors 0.03%; agar-agar 0.02%; and xanthan gun 0.01%.

22. A complex confection of claim 21 where both white chocolate and brown chocolate in distinct regions comprise the outer shell of the confection.

23. A complex confection of claim 21 where the outer shell of chocolate appears broken open and the inner three dimensional sculpted object can be seen.

24. A composition comprising a complex confection comprising:
(a) a chocolate shell resembling an Easter egg and defining a cavity therewithin; and
(b) a marshmallow confection resembling a ducky,
wherein the marshmallow confection is disposed within the cavity of the chocolate shell.

25. The complex confection of claim 24, wherein the chocolate shell is made from the following ingredients, listed in order by weight: sugar; cocoa butter; whole milk powder; cocoa mass; skimmed milk powder; one or more emulsifiers selected from the group comprising soya lecithin, and one or more flavoring products selected from the group comprising vanillin.

26. The complex confection of claim 25, wherein the marshmallow confection is made from the following ingredients, listed in order by weight: sugar; glucose syrup; water; gelatin; lactic acid; one or more artificial flavors selected from the group comprising strawberry; corn starch; cream of tartar; one or more artificial coloring products selected from the group comprising FD&C Yellow 5, FD&C Red 40, FD&C Blue 1, and FD&C Yellow 6; agar-agar, and xanthan gum.

27. (canceled)

28. (canceled)

29. (canceled)

30. (canceled)
